(19) United States
(12) Patent Application Publication
(10) Pub. No.: US 2003/0093425 A1
(43) Pub. Date: May 15, 2003

(54) System, method, and computer program product for accessing batch job service requests

(75) Inventor: John Richard Shelton, San Martin, CA (US)

Correspondence Address: John L. Rogitz, Rogitz & Associates, Suite 3120, 750 B. Street, San Diego, CA, 92101, US

(73) Assignee: International Business Machines Corporation, Armonk, NY

(21) Appl. No.: 10/010,007

(22) Filed: Nov. 9, 2001

(51) Int. Cl. G06F 7/00

(52) U.S. Cl. 707/10

(57) ABSTRACT

A system and method for accessing batch job service requests includes means for modeling the batch job service requests into objects. The method includes creating a jobEvent and a JobStatistics class. An application program is allowed to issue service requests and in response thereto, service request actions are executed.

### TECHNICAL FIELD

The present invention relates generally to object oriented computer programs.

### BACKGROUND OF THE INVENTION

A primary use of computer systems is the storage, manipulation, and retrieval of data. These actions can be achieved, e.g., through the use of object oriented programming (OOP). OOP is a programming scheme that is organized around “objects” rather than “actions,” i.e., data rather than logic. In this type of programming, programmers define not only the data type of a data structure, but also the types of operations or functions that can be applied to the data structure. In this way, the data structure becomes an object that includes both data and functions.

To perform OOP, a programmer needs an object-oriented programming language (OOPL), e.g., Java and C++. In generally, the first step in OOP is to identify all the objects that are to be manipulated and how they relate to each other, i.e., data modeling. Once an object is identified, it is generalized as a class of objects, the type of data that it contains is defined, and the logic sequences that can manipulate the object are defined. Each distinct logic sequence is known as a method. A real instance of a class is called an object, or in some environments, an “instance of a class.” The object is executed or run in a computer. The methods of the object provide computer instructions and the class object characteristics provide relevant data. A user communicates with objects and the objects communicate with each other—with well-defined interfaces called messages.

OOP makes it possible to define subclasses of data objects that share some or all of the main class characteristics. This property, commonly called “inheritance,” forces a more thorough data analysis, reduces development time, and ensures more accurate coding. Moreover, since a class defines only the data it needs to be concerned with, when an instance of that class (an object) is run, the code will not be able to accidentally access other program data. This property of “data hiding” provides greater system security and avoids unintended data corruption. In OOP, the definitions of classes are reusable—not only by the program for which it is initially created by also by other object-oriented programs. Thus, they can be more easily distributed for use in networks.

Typically, service requests from object-oriented application programs are batch processed, i.e., a group of documents or files are process all at once—in a batch. Thus, with batch processing, a user gives a computer a job, e.g., printing form letters to everyone on a mailing list, and waits for the entire job to be completed. OOP applications can code existing batch job service interfaces to access batch job services by using low-level calls with system service routines to create service environments, to submit, to query, to cancel, to purge batch jobs, to notify when a job ends, and to access job datasets. The present invention recognizes that batch job service request can be modeled into objects in order to ease development work and eliminate low-level coding.

### SUMMARY OF THE INVENTION

Having recognized the above drawbacks, the present invention provides the solutions noted below to one or more of them.

A method for computer batch processing includes defining a data class representing a respective batch service. Upon occurrence of a batch event, an event object is defined. Thereafter, the data class and or the event object is accessed in order to execute a batch service request.

Also in a preferred embodiment, a user identification and user password are established and stored, e.g., at a user computer. The user identification and password are verified before a batch service request is executed. Preferably, the service request invokes one of the following: submitJob, getJobStatistics, getJobDSN, getJobDataset, getDataset, cancelJob, purgeJob, holdJob, and releaseJob.

In another aspect of the preferred embodiment of the present invention, a system for batch processing of data includes a server and a database connected to the server. The database includes data that is the target of batch job service requests. The system also includes a user computer connected to the server. In this aspect the user computer includes a program for modeling the batch job service requests as objects.

In yet another aspect of the preferred embodiment of the present invention, a computer program device includes a computer readable means having logic means for modeling the batch job service requests as objects. The computer readable means includes logic means for defining a data class representing a respective batch service. Also, the computer readable means includes logic means for defining an event object upon occurrence of a batch event and logic means for accessing: the data class, and the event object to execute a batch service request.

The present invention will now be described, by way of example, with reference to the accompanying drawings, in which:

### BRIEF DESCRIPTION OF THE DRAWINGS

FIG. 1 is a block diagram of an exemplary system architecture;

FIG. 2 is a flow chart of the configuring logic of the preferred embodiment of the present invention;

FIG. 3 is a flow chart of the operating logic of the preferred embodiment of the present invention; and

FIG. 4 is the general schema for the operating code.

### DESCRIPTION OF AN EMBODIMENT OF THE INVENTION

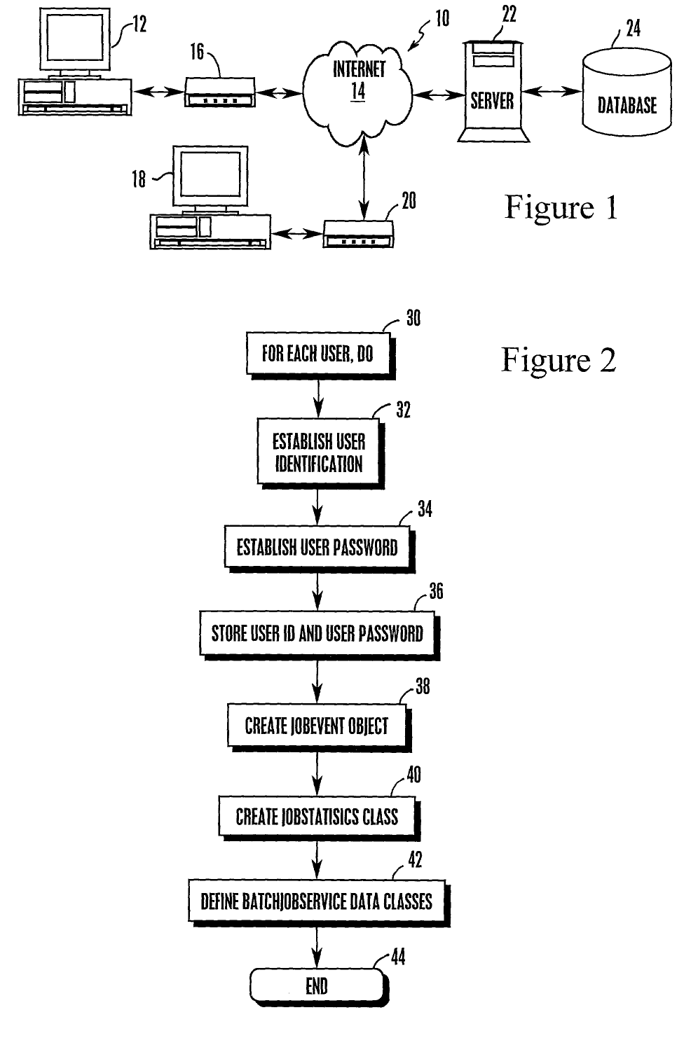

Referring initially to FIG. 1, one exemplary, non-limiting embodiment of the present system is shown and generally designated 10. As shown in FIG. 1, the system 10 includes a first user computer 12 connected to the Internet 14 via a first modem 16. FIG. 1 also shows a second user computer 18 connected to the Internet 14 via a second modem 20. It can be appreciated that the modems 16, 20 can be telephone modems, cable modems, DSL modems, etc. that provide connections to the Internet 14 by telephone line, television cable, LAN, WAN, T1, or any other means well known in the art.

As shown in FIG. 1, a server 22 is also connected to the Internet 14. The server 22, in turn, is connected to a database 24. It is to be appreciated that the logic described below can be executed locally, e.g., at either user computers 12, 18 or it can be executed remotely, e.g., at the server 22.

While the preferred implementations of the user computers 12, 18 are personal computers manufactured by International Business Machines (IBM), the computers 12, 18 can be any computers, including Unix computers, or OS/2 servers, Windows NT servers, or laptop computer. (Unix is a registered trademark of The Open Group in the United States and other countries. OS/2 is a registered trademark of International Business Machines Corporation in the United States, other countries, or both. Windows NT is a trademark of Microsoft Corporation in the United States, other countries, or both.) Additionally, the computers 12, 18 can be hand held computers or any other devices that receive Internet content. Each user computer 12, 18 and/or the server 22 can include a series of computer-executable instructions, as described below, that can model batch job service requests into objects.

The instructions may be contained in random access memory (RAM) within each computer 12, 18 and/or server 22 or on a data storage device with a computer readable medium, such as a computer diskette. Or, the instructions may be stored on a magnetic tape, conventional hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be written, e.g., using C++ or Java.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

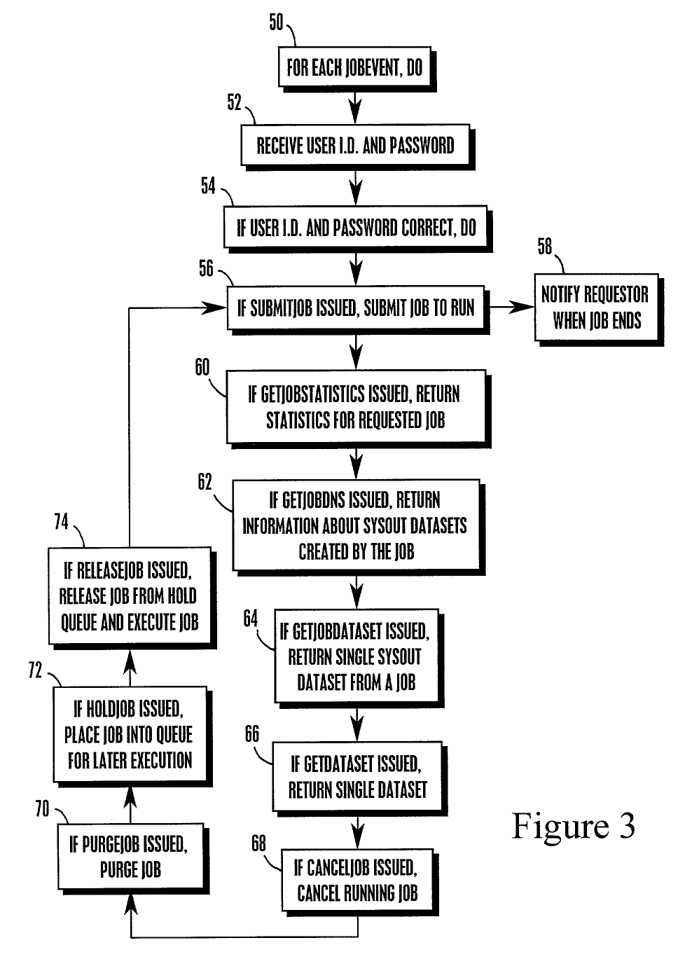

Referring to FIG. 2, the configuration logic of the present invention is shown and commences at block 30 with a do loop, wherein for each user, the succeeding steps are performed. At block 32, a user identification is established. Next, at block 34, a user password is established. Moving to block 36, the user id and password are stored, e.g., at the local computers 12, 18 or at the sever 22. The present invention creates a secure environment using the user id and password supplied by a batch job service requester and issues the system service requests from that secure environment. Proceeding to block 38, a JobEvent object is created. The JobEvent object can be created, e.g., when an event that a requester has registered interest occurs. It is to be understood that the JobEvent can include information about the job and a JobStatisticsObject.

Returning to the description of the logic, at block 40, a JobStatistics class is created. The JobStatistics class can contain information about a job, e.g., its phase, the datasets associated with it, its return code, etc. In a preferred embodiment, the JobStatistics class is created when a JobEvent occurs or when requested by a direct method call. Moving to block 42, the BatchJobService classes, described below, are defined. The configuration logic then ends at state 44.

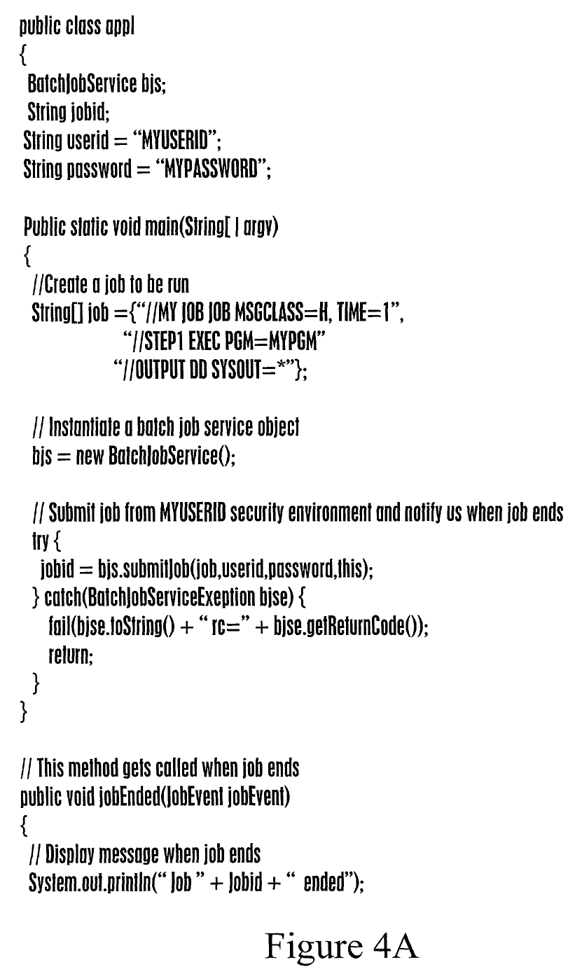

Referring now to FIG. 3, the operating logic of the present invention is shown and commences at block 50 with a do loop wherein for each JobEvent, the following steps are performed. At block 52, the user id. and password are received, e.g., at the local computers 12, 18 or the remote server 22. Next, at block 54, an internal do loop is entered wherein if the user id. and password are correct, a series of do loops following block 54 are processed. These do loops represent possible service requests that can be issued by the application program and the actions that can result in response to those service requests. In other words, the below discussion sets forth methods of the BatchJobService classes discussed above.

For example, at block 56, when a “submitJob” service request is issued, the job is submitted to run using a submitJob class. Next, at block 58, the requester can be notified when the job ends. Moving to block 60, if a “getJobStatistics” service request is issued, the return statistics for the requested job are returned to the requester using a getJobStatistics class. Continuing to block 62, if a “getJobDSN” service request is issued, information about SYSOUT datasets created by the job are returned to the requester using a getJobDSN class.

If a “getJobDataset” service request is issued at block 64, a single SYSOUT dataset from a job is returned to the job requester using a getJobDataset class. Moreover, at block 66, if a “getDataset” service request is issued, a single dataset, which may or may not be associated with a job is returned to the requester using a getDataset class. Moving to block 68, if a “cancelJob” service request is issued, the current running job is cancelled using a cancelJob class. Additionally, at block 70, if a “purgeJob” service request is issued, the current job is purged using a purgeJob class. On the other hand, at block 72, if a “holdJob” service request is issued, the current job is placed into a queue for later execution using a holdJob class. Finally, at block 74, if a “releaseJob” service request is issued, the job is released from the hold queue and executed using a releaseJob class. The logic then returns to block 56 and continues as described above. It is to be understood that although for ease of discussion FIG. 3 is presented as a flow chart, the various methods can be separately invoked. It is also to be understood that the “requester” described above is an application, i.e., a computer program, running at a user computer 12, 18. The requestor can invoke one or more of the BatchJobService classes described above in order to manipulate data stored at the user computer 12, 18 or the database 24.

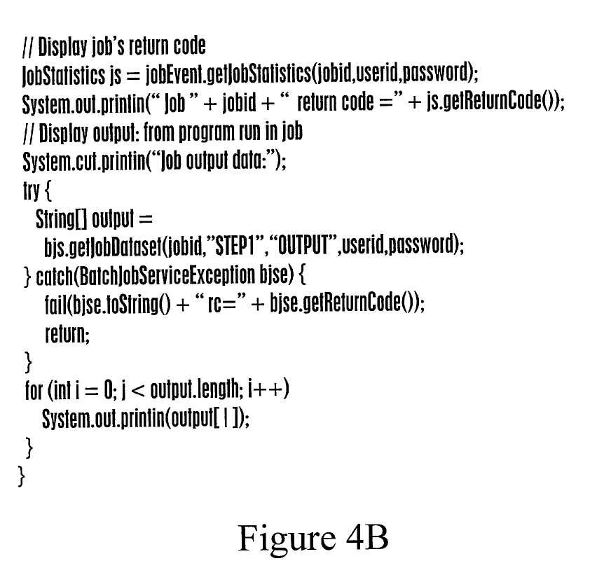

Referring briefly to FIG. 4, an exemplary, non-limiting application program is shown. This program is used to perform the steps described above in conjunction with FIGS. 2 and 3.

It is to be understood that the system, method, and computer product described above models batch job service request into objects to ease application development work. Moreover, low-level encoding necessary to issue system service requests is eliminated and application programs are allowed to easily submit batch jobs, query their status, obtain statistics on them, cancel jobs, purge jobs, and access the datasets associated with the jobs. The above-described method can also notify the application program when a job ends or when other job events occur that the application program registers an interest in.

While the particular SYSTEM, METHOD, AND COMPUTER PROGRAM PRODUCT FOR ACCESSING BATCH JOB SERVICE REQUESTS as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

I claim:

1. A method for computer batch processing, comprising:
defining at least one data class representing a respective batch service;
defining at least one event object upon occurrence of a batch event; and
accessing at least one of: the data class, and the event object to execute a batch service request.

2. The method of claim 1, further comprising the act of:
establishing a user identification;
establishing a user password; and
storing the user identification in conjunction with the user password.

3. The method of claim 2, further comprising the act of:
verifying a user identification and user password before executing a batch service request.

4. The method of claim 1, wherein the service request invokes at least one of the following: submitJob, getJobStatistics, getJobDSN, getJobDataset, getDataset, cancelJob, purgeJob, holdJob, and releaseJob.

5. A system for batch processing of data, comprising:
at least one server;
at least one database connected to the server, the database including data that is the target of batch job service requests; and
at least one user computer connected to the server, the user computer including a program for modeling the batch job service requests as objects.

6. The system of claim 5, wherein the program includes:
means for defining at least one data class representing a respective batch service;
means for defining at least one event object upon occurrence of a batch event; and
means for accessing at least one of: the data class, and the event object to execute a batch service request.

7. The system of claim 6, wherein the program further comprises:
means for establishing a user identification;
means for establishing a user password; and
means for storing the user identification in conjunction with the user password.

8. The system of claim 7, wherein the program farther comprises:
means for verifying a user identification and user password before executing a batch service request.

9. The system of claim 6, wherein the batch service request invokes at least one of the following: submitJob, getJobStatistics, getJobDSN, getJobDataset, getDataset, cancelJob, purgeJob, holdJob, and releaseJob.

10. A computer program device, comprising:
a computer readable means having logic means for modeling the batch job service requests as objects, comprising:
logic means for defining at least one data class representing a respective batch service;
logic means for defining at least one event object upon occurrence of a batch event; and
logic means for accessing at least one of: the data class, and the event object to execute a batch service request.

11. The computer program device of claim 10, wherein the program further comprises:
logic means for establishing a user identification;
logic means for establishing a user password; and
logic means for storing the user identification in conjunction with the user password.

12. The computer program device of claim 11, wherein the program further comprises:
logic means for verifying a user identification and user password before executing a batch service request.

13. The computer program device of claim 10, wherein the batch service request is at least one of the following: submitJob, getJobStatistics, getJobDSN, getJobDataset, getDataset, cancelJob, purgeJob, holdJob, and releaseJob.
